(19) United States
(12) Patent Application Publication
(10) Pub. No.: US 2026/0346600 A1
(43) Pub. Date: Nov. 5, 2026

(54) A RESERVOIR ASSEMBLY FOR FLEXOGRAPHIC PRINTING

(71) Applicant: PRIMEBLADE SWEDEN AB, Sunne (SE)

(72) Inventors: Bartek Kaplan, Sollentuna (SE); Jimmy Nyström, Sunne (SE)

(73) Assignee: PRIMEBLADE SWEDEN AB, Sunne (SE)

(21) Appl. No.: 19/118,084

(22) PCT Filed: Oct. 4, 2023
(86) PCT No.: PCT/EP2023/077376

§ 371 Date: Apr. 3, 2025

(30) Foreign Application Priority Data
Oct. 6, 2022 (SE) 2251159-6

(51) Int. Cl. B41F 31/06; B41F 5/24; B41F 9/06; B41F 9/10; B41F 31/02

(52) U.S. Cl. CPC B41F 31/06; B41F 5/24; B41F 9/063; B41F 9/066; B41F 9/068; B41F 9/1063; B41F 31/027

(57) ABSTRACT

The invention provides a reservoir assembly (2) for a flexographic printing process,—wherein the reservoir assembly (2) is adapted to form, with an anilox metering roll (3), a chamber for containing ink,—wherein the reservoir assembly (2) comprises an elongated base (201) adapted to extend in a direction of a rotational axis of the anilox metering roll (3),—wherein the reservoir assembly (2) further comprises a doctor blade (2022) which is fixed to the base (201),—wherein the reservoir assembly (2) comprises a sealing assembly (203) for sealing an axial end of the chamber, or sealing a sub-chamber of the chamber from another sub-chamber of the chamber,—wherein the sealing assembly comprises a seal (2031) which presents a roll surface (2032) which is adapted to sealingly engage a circumferential surface (301) of the roll (3),—wherein the seal (2031) is attached to the doctor blade (2022) on a longitudinal surface (2024) of the doctor blade.

### TECHNICAL FIELD

The invention relates to a reservoir assembly for a flexographic printing process. The invention also relates to a combination of a reservoir assembly and an anilox metering roll, and to a printing press.

### BACKGROUND

Flexographic printing is a rotary letter press printing process which traditionally uses flexible rubber, or other elastomer, printing plates and liquid, fast drying ink.

As described in U.S. Pat. No. 5,243,907A, in flexographic printing, a web to be imprinted is passed between an impression cylinder and a plate cylinder, from which the ink is transferred to the web. Ink is applied to the plate cylinder by an anilox metering roll. The circumferential surface of the anilox roll forms a large number of small cells. Ink is fed to the anilox roll by a chambered doctor blade assembly. Thereby, the ink fills the cells of the surface of the anilox roll. The chambered doctor blade assembly typically comprises a base forming an elongated cavity, and a pair of doctor blades which contact the anilox roll. The chambered doctor blade assembly may also comprise a sealing assembly at each end of the chamber, herein referred to as an end sealing assembly. The surface of the anilox roll, and the chambered doctor blade assembly define a closed chamber for containing the ink. Thereby, the doctor blades are distributed in the circumferential direction of the anilox roll. Thereby, the doctor blades delimit the exposure of the anilox roll to the chamber. As the anilox roll rotates, the doctor blades shave surplus ink from the surface of the anilox roll. As a result, ink is carried only in the interior of the cells on the roll's surface and not on the lands between cells. This results in a uniformly metered quantity of ink being applied to the surface of the plate cylinder.

Said US patent suggests that in cases where it is desired to print more than one color on a web, which requires more than one color of ink, said ink chamber is divided into two or more sub-chambers by one or more dividers. These dividers are designed to maintain a fluid-tight seal between compartments in the ink fountain and to maintain a seal against the anilox roll. Each seal is contoured to sealingly engage the circumferential surface of the roll. A seal retainer is provided for retaining the seal in sealing engagement with the roll. A pneumatic bladder acts on the seal retainer for resiliently biasing the seal into sealing engagement with the roll.

A problem in flexographic printing machines is that seals of dividers of ink chambers is that ink may enter between the seals and the doctor blades. Thereby, the sealing function of the dividers may be compromised, and ink may leak from one sub-chamber to another sub-chamber. A similar problem may occur with seals for sealing axial ends of ink chambers, whereby ink may leak out of the chambers.

GB2278315A describes a chambered doctor blade comprising a chambered doctor blade body on which a working doctor blade and a closure strip are arranged. The chambered doctor blade is sealed laterally by side portions. In one embodiment described, the document suggests side portions being magnetised for providing an attraction to the ends of the working doctor blade, the closure strip and the chambered doctor blade.

However, there is still a desire to further improve the sealing of an ink reservoir for flexographic printing.

### SUMMARY

An object of the invention is to provide a durable and reliable sealing function of an ink reservoir for flexographic printing.

The object is reached with a reservoir assembly for a flexographic printing process,
wherein the reservoir assembly is adapted to form, with an anilox metering roll, a chamber for containing ink,
wherein the reservoir assembly comprises an elongated base adapted to extend in a direction of a rotational axis of the anilox metering roll,
wherein the reservoir assembly further comprises a doctor blade which is fixed to the base,
wherein the reservoir assembly comprises a sealing assembly for sealing an axial end of the chamber, or sealing a sub-chamber of the chamber from another sub-chamber of the chamber,
wherein the sealing assembly comprises a seal which presents a roll surface which is adapted to sealingly engage a circumferential surface of the roll,
wherein the seal is attached to the doctor blade on a longitudinal surface of the doctor blade.

The attachment of the seal to the doctor blade reduces tendencies of ink to enter between the seal and the doctor blade. Thereby, the risk of ink leakage past the seal is reduced. Further, the attachment of the seal on a longitudinal surface of the doctor blade, allows the seal to stabilize the doctor blade. Thereby, movements of an edge of the doctor blade along the circumferential direction of the blade is prevented. Thus, the seal serves to keep the doctor blade, in particular the edge thereof, in its desired position. Thereby, a durable and reliable sealing function is provided.

The doctor blade may extend along the rotational axis of the roll. The doctor blade may be in contact with the roll. However, in some embodiments, there may a distance between the doctor blade and the roll. This distance may be relatively small.

The doctor blade may be elongated. Thereby, the longitudinal direction of the doctor blade is preferably parallel with the rotational axis of the roll. The doctor blade may present end surfaces at ends of the longitudinal extension of the doctor blade. The longitudinal surface, on which the seal is attached, may extend from one of the end surfaces to the other of the end surfaces. Thus, the longitudinal surface, on which the seal is attached, may extend from one of the longitudinal ends of the doctor blade to the other of the longitudinal ends of the doctor blade. In a transverse cross-section, the doctor blade may have an elongated shape. The longitudinal surface of the doctor blade may form a limitation of the cross-section along a longitudinal direction of the cross-section.

Preferably, the seal abuts internal longitudinal surfaces of the base.

The seal may be made in a flexible material, for example a flexible foam material. The Young's modulus of the flexible seal material may be equal to or less than 3000 MPa, for example equal to or less than 2000 MPa, for example equal to or less than 1300 MPa, for example equal to or less than 500 MPa. The Young's modulus of the flexible seal material may be equal to or greater than 0.1 MPa, for example equal to or greater than 0.2 MPa.

In some embodiments the seal is attached to the doctor blade by means of an adhesive. Thereby, the attachment may be provided by a single layer of adhesive. Alternatively, the adhesive may be a part of a double-sided tape used for the attachment.

The seal may present a blade surface which faces the doctor blade. Said surface may extend from the roll surface and in a transverse direction of the doctor blade.

In some embodiments, the seal is attached to the doctor blade by a magnetic force. The attachment of the seal to the doctor blade may be made by means of one or more magnets. The one or more magnets may be incorporated in the seal and located at a distance from the doctor blade. Thereby, the seal may be in direct contact with the doctor blade. The doctor blade may be made in a material which is magnetically attracted by the one or more magnets, such as steel.

In some embodiments, for the attachment of the seal to the doctor blade, one or more magnets are inserted into one or more pockets in the seal. Thereby, the magnets can be re-used when the seals are exchanged during a service operation of the reservoir assembly.

In some embodiments, the seal is attached to the doctor blade by means of a magnetic layer. The magnetic layer may be produced by applying a magnetic liquid to the seal, and allowing the liquid to cure. The doctor blade may be made in a material which is magnetically attracted by the magnetic layer, such as steel. In some embodiments, the magnetic layer may be applied to the doctor blade. Thereby, the seal may be provided with a material which is magnetically attracted by the magnetic layer.

An particular advantage with the seal being attached to the doctor blade by a magnetic force, is that the same magnetic force can be used to attract and hold any metal debris from the doctor blade. The debris may be produced as the doctor blade is worn during the operation of the printer, similar to the production of metal shavings. Such debris might, if it is separated from the doctor blade, move around in the chamber and cause problems, such as damage or leaks. Thus, the magnetic force may provide the double function of attaching the seal to the doctor blade, as well as holding or securing metal debris from the doctor blade.

Preferably, the reservoir assembly is adapted to be positioned in relation to the roll, so that during use of the reservoir assembly, when the circumferential surface of the roll moves past the reservoir assembly, the circumferential surface of the roll moves past the roll surface of the seal and subsequently past the doctor blade. Thereby, the attachment of the seal to the doctor blade is provided at a downstream end of the roll surface of the seal which contour is in contact with the roll.

In some embodiments, the reservoir assembly comprises two doctor blades, arranged to be distributed in a circumferential direction of the roll so as to be at a distance from each other, wherein the roll surface of the seal extends between the doctor blades. Thereby, said doctor blades may include an upstream doctor blade and a downstream doctor blade.

Thereby, the reservoir assembly is adapted to be positioned in relation to the roll so that during use of the reservoir assembly, when the circumferential surface of the roll moves past the reservoir assembly, the circumferential surface of the roll moves past the upstream doctor blade, subsequently past the roll surface, and subsequently past the downstream doctor blade. Thereby, the seal is preferably attached to the downstream doctor blade.

Thereby, the attachment is provided at the doctor blade at which there may otherwise be a strong tendency for ink to enter between the doctor blade and the seal. In some embodiments, the seal is attached to both doctor blades. It is also conceivable that the seal is attached to only the upstream doctor blade.

In some embodiments, the sealing assembly comprises a flexible biasing device forming one or more cavities, and being arranged to receive a pressurized fluid in the one or more cavities, for biasing the seal into sealing engagement with the roll. Thereby, the sealing function of the seal towards the roll may be secured.

In a plane that is perpendicular to the rotational axis of the roll, the seal may fully enclose the biasing device. Alternatively, the biasing device may be positioned with a back side thereof adjacent the base, and be, in said plane, surrounded by the seal at the remaining sides of the biasing device. The seal may form a single element. The seal and the biasing device may be separate elements. The biasing device may be in direct contact with the seal. In some embodiments, the biasing device may form two or more cavities, for receiving pressurized fluid. Thereby, the reservoir assembly may comprise a pressurizing device connected to the biasing device, such that the pressure in one or more, but less than all, of the cavities, can be controlled independently of a control of the pressure in the remaining cavity or cavities. The biasing device may be adapted so that the cavities are distributed in the circumferential direction of the cylinder.

The object is also reached with a combination of a reservoir assembly and an anilox metering roll comprising a reservoir assembly according to any one of the claims for the reservoir assembly. The object is also reached with a printing press comprising a reservoir assembly according to any one of the claims for the reservoir assembly.

The object is also reached with a method for assembling a combination of a reservoir assembly and an anilox metering roll for a flexographic printing process. The reservoir assembly is adapted to form, with the anilox metering roll, a chamber for containing ink. The reservoir assembly comprises a sealing assembly for sealing an axial end of the chamber, or sealing a sub-chamber of the chamber from another sub-chamber of the chamber. The method comprises assembling the reservoir assembly, wherein assembling the reservoir assembly comprises mounting a seal of the sealing assembly to an elongated base adapted to extend in a direction of a rotational axis of the anilox metering roll, which seal presents m surface of the roll. Assembling the reservoir assembly further comprises fixing a doctor blade to the base. The method further comprises providing the seal with one or more pockets, wherein, after the steps of mounting the seal to the base and fixing the doctor blade to the base, one or more magnets are inserted into the one or more pockets, so that the seal is attached to the doctor blade by a magnetic force between the one or more magnets and the doctor blade.

After the steps of mounting the seal to the base and fixing the doctor blade to the base, and before the step of inserting the one or more magnets into the one or more pockets, the seal may abut the doctor blade. The method preferably further comprises assembling the reservoir assembly with the anilox metering roll so as to form the chamber for containing ink.

The method facilitates the assembly of the reservoir assembly. If the one or more magnets are placed in the seal before the seal and doctor blade are mounted to the base, the magnets and the doctor blade will be magnetically attracted to each other during the assembly, which may cause problems and delays during the assembly. By inserting the one or more magnets are after the steps of mounting the seal to the base and fixing the doctor blade to the base, the latter steps can be performed without any magnetic attraction between the doctor blade and the magnets. Thereby, the time consumed for the assembly can be reduced. Also, the risk of errors during the assembly can be reduced, whereby a durable and reliable function of the seal can be secured.

Providing the seal with one or more pockets may be done before assembling the reservoir assembly, e.g. when the seal itself is manufactured. It should be noted that the step of mounting the seal to the base preferably precedes the step of fixing the doctor blade to the base, but it possible to perform these steps in the opposite order.

The one or more pockets may form one or more openings in a surface of the seal which faces in a direction which, in the assembled state of the combination of the reservoir assembly and the roll, is substantially parallel with the rotational axis of the roll. Thereby, the openings may be external or internal to the chamber for containing ink. In the former case, the magnets are introduced from outside of the reservoir assembly, which may facilitate the operation. However, in some embodiments, the magnets are introduced from the inside of the reservoir assembly.

In some embodiments, the one or more magnets are kept away from the seal and the doctor blade during the steps of mounting the seal to the base and fixing the doctor blade to the base. However, in other embodiments, the one or more magnets are attached to the seal or the doctor blade during the steps of mounting the seal to the base and fixing the doctor blade to the base. Thereby, the one or more magnets are preferably attached and kept at a distance from the one or more pockets or any surface for contact between the seal and the doctor blade.

Further advantages and advantageous features of the invention are disclosed in the following description and in the dependent claims.

### BRIEF DESCRIPTION OF THE DRAWINGS

Below, embodiments of the invention will be described with reference to the drawings, in which:

FIG. 1 shows schematically a cross sectional view of parts of a printing press for flexographic printing with a reservoir assembly according to an embodiment of the invention,

FIG. 2 shows, in a side view as indicated by the arrow II in FIG. 1, the reservoir assembly and a rotatable roll of the printing press,

FIG. 3 shows a cross-section indicated by the arrows III-III in FIG. 2 of the reservoir assembly and the rotatable roll,

FIG. 4 shows a detail of FIG. 3,

FIG. 5 shows a cross-sectional view similar to the one in FIG. 4, of an alternative embodiment of the invention, and

FIG. 6 and FIG. 7 show respective cross-sections of reservoir assemblies and parts of rotatable rolls, in further alternative embodiments,

FIG. 8 shows the view of FIG. 5, without one of the parts shown in FIG. 5,

FIG. 9 shows a cross-sectional view oriented as indicated with the arrows IX-IX in FIG. 8, and

FIG. 10 is a flow diagram depicting steps in an embodiment of a method according to the invention.

### DETAILED DESCRIPTION OF EMBODIMENTS OF THE INVENTION

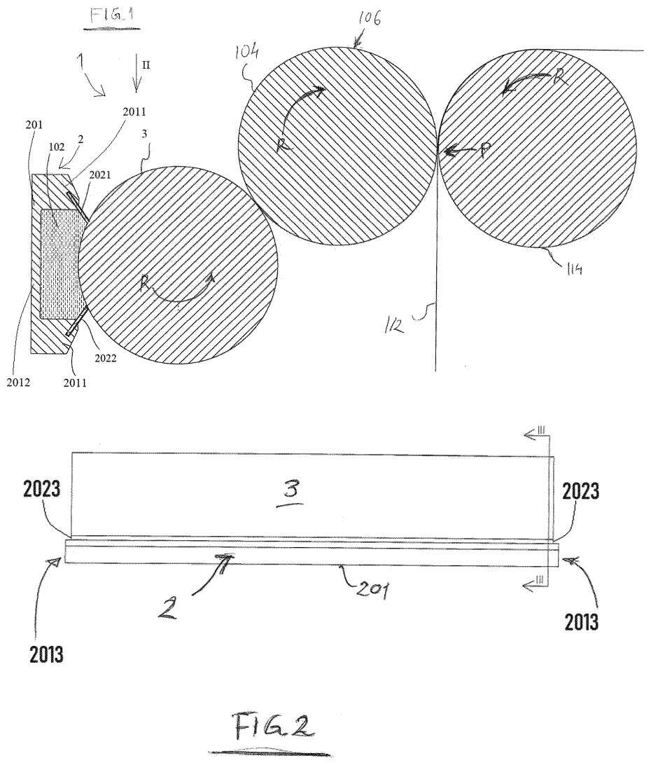

FIG. 1 shows schematically a cross sectional view of a printing press 1 for flexographic printing. The printing press comprises a first rotatable cylinder 3, also called anilox metering roll, that transfers ink 102 from a reservoir assembly 2 to a second rotatable cylinder 104. The anilox metering roll 3 transfers a uniform thickness of ink to a flexible printing plate 106 mounted on the second rotatable cylinder 104, also called plate cylinder.

The reservoir assembly 2 comprises a base 201 extending in the direction of the rotational axis of the first rotatable cylinder 3. The base comprises two walls 2011 and a root 2012 connecting the walls. The base has a U-shaped cross-section. The base extends along the first rotatable cylinder 3.

The reservoir assembly 2 comprises two doctor blades 2021, 2022 which is fixed to respective walls 2011 of the reservoir assembly 2. The doctor blades are distributed on opposite sides of a longitudinal symmetry plane of the base 201. The doctor blades are in contact with the first rotatable cylinder 3. Thereby, the base and the doctor blades form a reservoir for the ink 102. The doctor blades 2021, 2022 scrapes the first rotatable cylinder 3 to ensure that a uniform amount of ink 102 is delivered to the flexible printing plate 106. The reservoir assembly 2 forms, with the anilox metering roll 3, a chamber for containing ink.

An image formed on the printing plate 106 is transferred to an image-receiving substrate 112, in form of a web. The image-receiving substrate 112 is arranged to run between the second rotatable cylinder 104 and a third cylinder 114, also called impression cylinder or print anvil. The image is transferred during rotation R of the second rotatable cylinder 104 and at the same time by applying a pressure P to the second rotatable cylinder 104 by the third cylinder 114.

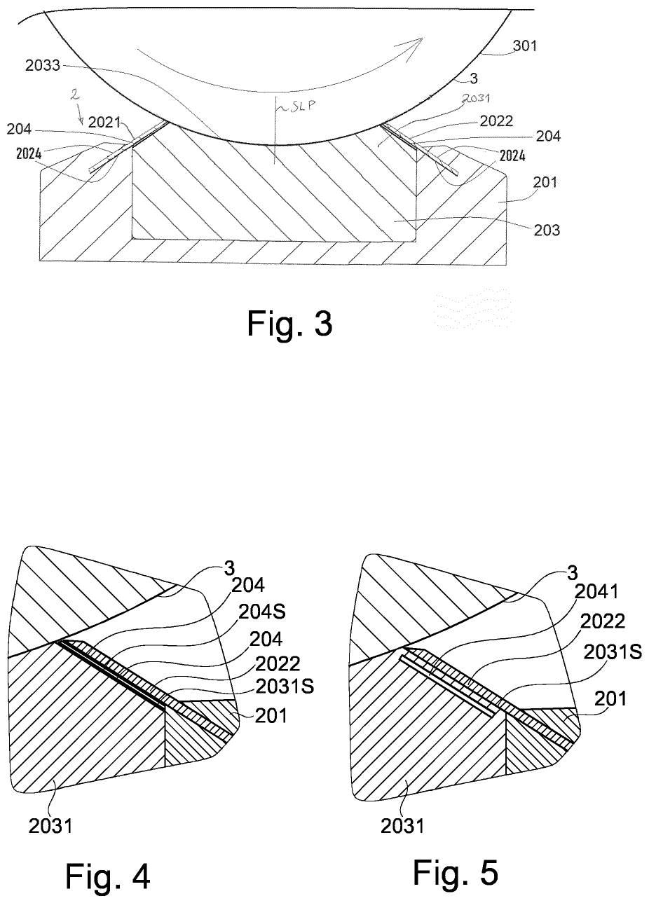

Reference is made also to FIG. 2 and FIG. 3. FIG. 2 shows the reservoir assembly 2 and the first rotatable cylinder 3 in a view from above in FIG. 1. FIG. 3 shows a cross-section as indicated by the arrows III-III in FIG. 2.

The reservoir assembly 2 comprises two sealing assemblies 203 for sealing respective axial ends 2013 of the reservoir assembly 2. It should be noted that a sealing assembly according to embodiments of the invention may also seal a sub-reservoir of the reservoir formed by the reservoir assembly 2 from another sub-reservoir of the reservoir.

One of the sealing assemblies can be seen in FIG. 3. The sealing assembly 203 comprises a seal 2031 presenting a roll surface 2033 to sealingly engage a circumferential surface of the cylinder 3. The seal 2031 also sealingly engages the doctor blades 2021, 2022, as described closer below. The seal 2031 is made of a flexible material. The Young's modulus of the material of the seal 2031 may be equal to or less than 3000 MPa, preferably equal to or less than 2000 MPa, preferably equal to or less than 1300 MPa, preferably equal to or less than 500 MPa.

The doctor blades include an upstream doctor blade 2021 and a downstream doctor blade 2022. When the circumferential surface 301 of the roll moves past the reservoir assembly, the circumferential surface 301 of the roll moves past the upstream doctor blade 2021, subsequently past the roll surface 2033, and subsequently past the downstream doctor blade 2022.

The doctor blades 2021, 2022 are elongated. The longitudinal directions of the doctor blades are parallel with the rotational axis of the cylinder 3. The doctor blades present end surfaces 2023 (FIG. 2) at ends of the longitudinal extensions of the doctor blades. In transverse cross-sections (FIG. 3), the doctor blades have an elongated shape. Longitudinal surfaces 2024 of the doctor blades form limitations of the transverse doctor blade cross-sections along longitudinal directions of the cross-sections.

The doctor blades 2021, 2022 are partly inserted in base 201. For this, the doctor blades may be partly inserted in slots of base 201, or held by clamps or other fastening means of the base, to the remainder of the base.

The seal 2031 abuts internal longitudinal surfaces of the base 201. The seal 2031 also abuts longitudinal surfaces of the doctor blades 2021, 2022.

Reference is made also to FIG. 4. The seal 2031 is attached to the downstream doctor blade 2022. The attachment of the seal 2031 to the doctor blade 2022 is made by means of an adhesive 204. More specifically, a double-sided tape is located between the seal 2031 and the doctor blade 2022. The double-sided tape comprises a flexible sheet 204S. On both sides of the flexible sheet 204S, adhesive 204 is provided.

The attachment is provided between the doctor blade 2022 and a blade surface 2031S of the seal, which blade surface faces the doctor blade. Said blade surface extends from the surface of the roll 3 and in a transverse direction of the doctor blade 2022.

In alternative embodiments, the attachment of the seal 2031 to the doctor blade is provided by means of a single layer of adhesive 204.

In the embodiment described with reference to FIG. 1-FIG. 4, the seal 2031 is attached also to the upstream doctor blade 2021.

Reference is made to FIG. 5. In this embodiment the seal 2031 is attached to the doctor blade 2022 is made by means of a magnet 2041. The doctor blade 2022 is made in steel.

The magnet is incorporated in the seal 2031 and located at a distance from the doctor blade 2022. Thereby, the seal 2031 is attached to the doctor blade 2022 by a magnetic force.

In other embodiments, the attachment of the seal 2031 to the doctor blade is provided by means of a magnetic layer 204. The magnetic layer can be provided on a surface of the seal that faces the doctor blade. The magnetic layer may be produced by applying a magnetic liquid to the seal, and allowing the liquid to cure.

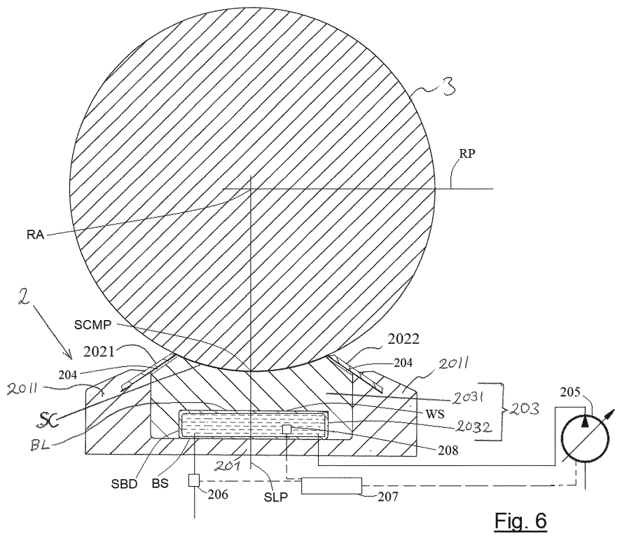

Reference is made to FIG. 6, showing an embodiment which is similar to the one described with reference to FIG. 1-4, but with differences as follows below.

As in the embodiment in FIG. 1-4, there are attachments 204 of the seal 2031 to the doctor blades 2021, 2022. Further, the sealing assembly 203 comprises a flexible biasing device 2032. The biasing device 2032 may be provided in the form of a bladder. The bladder may be made in a suitable material, such as rubber. The bladder may be vulcanized so as to fit into a space delimed by the seal 2031 and the base 201.

The biasing device 2032 forms a cavity and is arranged to receive a pressurized fluid in the cavity. The biasing device 2032 serves to bias the seal 2031 into sealing engagement with the cylinder 3. The biasing device 2032 also serves to bias the seal 2031 into sealing engagement with the doctor blades 2021, 2022.

The pressurization of the biasing device 2032 is provided by a pressurizing device. The pressurizing device comprises a fluid pump 205. The biasing device 2032 may be pressurized pneumatically or hydraulically. The fluid pump 205 may be a variable displacement pump. An adjustable valve 206 is arranged to release fluid from the biasing device so as to reduce the pressure therein.

The pressurizing device further comprises an adjustable valve 206, an electronic control unit 207, and a pressure sensor 208. The control unit 207 comprises a processor and a memory. The fluid pump 205 and the valve 206 are controllable to provide a pressure in the biasing device 2032 equal to a target pressure in the biasing device. For this the fluid pump and/or the valve are controllable by the control unit 207. The pressure sensor 208 is provided in the cavity of the biasing device 2032 to detect the pressure in the cavity. The control unit 207 is arranged to receive signals from the pressure sensor 208 representing the cavity pressure. The control unit 207 is arranged to control the fluid pump and/or the valve, in dependence on the cavity pressure, so as for the pressure in the cavity to be at the target pressure.

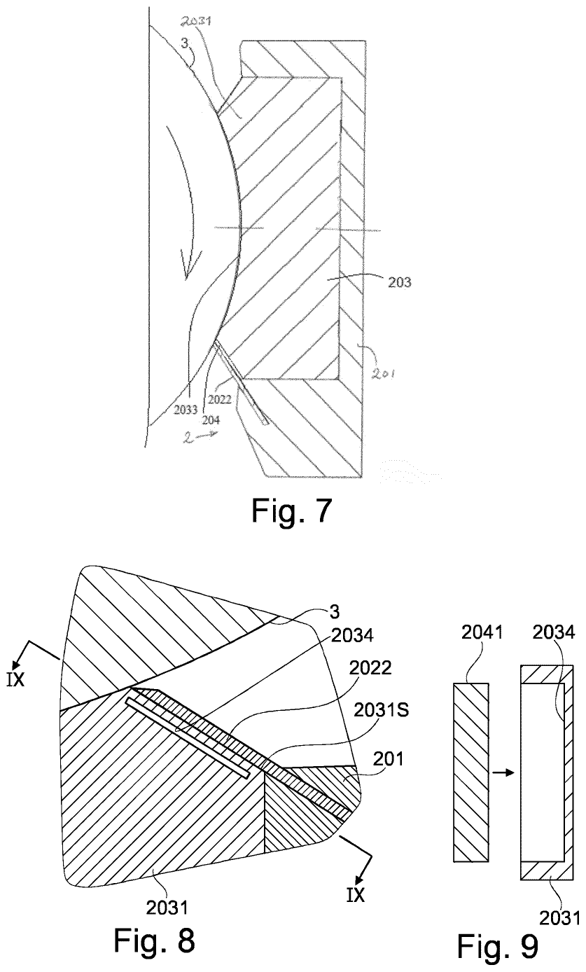

FIG. 7 shows a reservoir assembly 2 according to yet another embodiment of the invention. The embodiment is similar to the ones described above but with some differences. The reservoir assembly 2 is located on a side of the roll 3. As in the embodiments described above, the reservoir assembly 2 comprises a base 201 extending in the direction of the rotational axis of the cylinder 3. The reservoir assembly 2 further comprises a single doctor blade 2022 which is fixed to the base 201. The doctor blade is located at a lower part of the reservoir assembly 2. The reservoir assembly 2 comprises a sealing assembly 203 comprising a seal 2031 presenting a contour 2033 to sealingly engage a circumferential surface of the cylinder 3. The doctor blade 2022 is located at a downstream end of the seal contour 2033. An attachment 204 is provided to attach the seal 2031 to the doctor blade 2022.

Reference is made to FIG. 8, showing the embodiment in FIG. 5 without the magnet 2041. A pocket 2034 is provided in the seal 2031, to receive the magnet.

FIG. 9 depicts how the magnet 2041 is inserted into the pocket 2034.

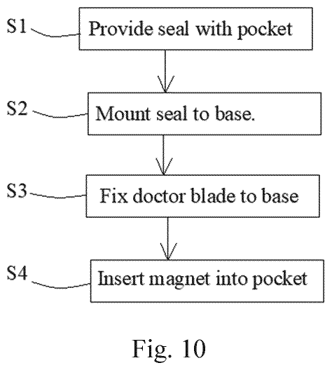

With reference to FIG. 10, a method for assembling the reservoir assembly 2, parts of which are depicted in FIGS. 5, 8, 9, will be described. The method comprises providing S1 the seal with the pocket 2034. The method further comprises mounting S2 the seal 2031 to the base, and fixing S3 the doctor blade 2022 to the base 201. The method further comprises, after the steps of mounting the seal to the base and fixing the doctor blade to the base, inserting S4 the magnet 2041 into the pocket 2034. Thereby, the seal 2031 is attached to the doctor blade 2022 by the magnetic force between the magnet and the doctor blade 2022.

It is to be understood that the present invention is not limited to the embodiments described above and illustrated in the drawings; rather, the skilled person will recognize that many changes and modifications may be made within the scope of the appended claims.

1. A reservoir assembly (2) for a flexographic printing process,
wherein the reservoir assembly (2) is adapted to form, with an anilox metering roll (3), a chamber for containing ink,
wherein the reservoir assembly (2) comprises an elongated base (201) adapted to extend in a direction of a rotational axis of the anilox metering roll (3),
wherein the reservoir assembly (2) further comprises a doctor blade (2022) which is fixed to the base (201),
wherein the reservoir assembly (2) comprises a sealing assembly (203) for sealing an axial end of the chamber, or sealing a sub-chamber of the chamber from another sub-chamber of the chamber,
wherein the sealing assembly comprises a seal (2031) which presents a roll surface (2032) which is adapted to sealingly engage a circumferential surface (301) of the roll (3),
characterized in that the seal (2031) is attached to the doctor blade (2022) on a longitudinal surface (2024) of the doctor blade.

2. A reservoir assembly according to claim 1, wherein the seal (2031) is attached to the doctor blade (2022) by means of an adhesive (204).

3. A reservoir assembly according to claim 1, wherein the seal (2031) is attached to the doctor blade (2022) by a magnetic force.

4. A reservoir assembly according to claim 1, wherein attachment of the seal (2031) to the doctor blade (2022) is made by one or more magnets (2041).

5. A reservoir assembly according to claim 4, wherein the one or more magnets (2041) are incorporated in the seal (2031) and located at a distance from the doctor blade (2022).

6. A reservoir assembly according to claim 1, wherein, for attachment of the seal (2031) to the doctor blade (2022), one or more magnets (2041) are inserted into one or more pockets (2034) in the seal (2031).

7. A reservoir assembly according to claim 1, wherein the seal (2031) is attached to the doctor blade (2022) by a magnetic layer (204).

8. A reservoir assembly according to claim 1, wherein the reservoir assembly (2) is dimensioned and configured to be positioned in relation to the roll (3), so that during use of the reservoir assembly (2), when the circumferential surface (301) of the roll (3) moves past the reservoir assembly, the circumferential surface (301) of the roll (3) moves past the roll surface (2032) of the seal (2031) and subsequently past the doctor blade (2022).

9. A reservoir assembly according to claim 1, wherein the reservoir assembly (2) comprises two doctor blades (2021, 2022), arranged to be distributed in a circumferential direction of the roll (3) so as to be at a distance from each other, wherein the roll surface (2032) of the seal (2031) extends between the doctor blades, wherein said doctor blades include an upstream doctor blade (2021) and a downstream doctor blade (2022), wherein the reservoir assembly (2) is dimensioned and configured to be positioned in relation to the roll (3) so that during use of the reservoir assembly, when the circumferential surface (301) of the roll moves past the reservoir assembly, the circumferential surface (301) of the roll moves past the upstream doctor blade (2021), subsequently past the roll surface (2032), and subsequently past the downstream doctor blade (2022), wherein the seal (2031) is attached to the downstream doctor blade (2022).

10. A reservoir assembly according to claim 1, wherein the sealing assembly (203) comprises a flexible biasing device (2032) forming one or more cavities (2041-2043), and being arranged to receive a pressurized fluid in the one or more cavities (2041-2043), for biasing the seal (2031) into sealing engagement with the roll (3).

11. A combination of a reservoir assembly (2) and an anilox metering roll (3) comprising a reservoir assembly according to claim 1.

12. A printing press comprising a reservoir assembly (2) according to claim 1.

13. A seal (2031) for a reservoir assembly (2) according to claim 1.

14. A method for assembling a combination of a reservoir assembly (2) and an anilox metering roll (3) for a flexographic printing process, wherein the reservoir assembly (2) is adapted to form, with the anilox metering roll (3), a chamber for containing ink, wherein the reservoir assembly (2) comprises a sealing assembly (203) for sealing an axial end of the chamber, or sealing a sub-chamber of the chamber from another sub-chamber of the chamber, wherein the method comprises assembling the reservoir assembly (2), wherein assembling the reservoir assembly comprises mounting a seal (2031) of the sealing assembly to an elongated base (201) adapted to extend in a direction of a rotational axis of the anilox metering roll (3), which seal presents a roll surface (2032) which is adapted to sealingly engage a circumferential surface (301) of the roll (3), wherein assembling the reservoir assembly further comprises fixing a doctor blade (2022) to the base, characterized by providing the seal with one or more pockets (2034), wherein, after the steps of mounting the seal to the base and fixing the doctor blade to the base, one or more magnets (2041) are inserted into the one or more pockets (2034), so that the seal (2031) is attached to the doctor blade (2022) by a magnetic force between the one or more magnets and the doctor blade (2022).
